(19) United States
(12) Patent Application Publication
(10) Pub. No.: US 2013/0171524 A1
(43) Pub. Date: Jul. 4, 2013

(54) POSITIVE ACTIVE MATERIAL FOR RECHARGEABLE LITHIUM BATTERY AND RECHARGEABLE LITHIUM BATTERY INCLUDING SAME

(71) Applicants: Jaephil CHO, Ulsan (KR); Mijung Noh, Daegu (KR)

(72) Inventors: Jaephil CHO, Ulsan (KR); Mijung Noh, Daegu (KR)

(73) Assignees: SK Innovation Co., Ltd., Seoul (KR); UNIST Academy-Industry Research Corporation, Ulsan (KR)

(21) Appl. No.: 13/598,933

(22) Filed: Aug. 30, 2012

(30) Foreign Application Priority Data
Dec. 30, 2011 (KR) 10-2011-0147886
Jul. 12, 2012 (KR) 10-2012-0076314

(51) Int. Cl. H01M 4/485; H01M 4/525; H01M 4/505

(52) U.S. Cl. 429/221; 429/223; 429/224; 429/231.3; 252/182.1

(57) ABSTRACT

Disclosed is a positive active material for a rechargeable lithium battery and a rechargeable lithium battery including the positive active material. The positive active material includes a lithiated intercalation compound capable of reversibly intercalating and deintercalating lithium and a metal oxide represented by the following Chemical Formula 1.

LiₓM_{y}M′_{1-y}O₄ [Chemical Formula 1]

In the above Chemical Formula M, M′, x, and y are the same as defined in the detailed description.
The positive active material easily provides lithium needed for the irreversible chemical/physical reaction at a negative electrode during the initial charge reaction, and thus increases charge capacity of a battery, decreases its irreversible capacity, and resultantly improves its cycle life.

### CROSS-REFERENCE TO RELATED APPLICATION

This application claims priority to and the benefit of Korean Patent Application Nos. 10-2011-0147886 filed on Dec. 30, 2011, and 10-2012-0076314 filed on Jul. 12, 2102, the entire contents of which are incorporated herein by reference.

### BACKGROUND OF THE INVENTION

(a) Field of the Invention

The present invention relates to a positive active material for a rechargeable lithium battery being capable of improving capacity performance and cycle life of a battery by providing lithium used for initial irreversible capacity, and a rechargeable lithium battery including the same.

(b) Description of the Related Art

Batteries generate electric power using an electrochemical reaction material for a positive electrode and a negative electrode.

Lithium rechargeable batteries generate electrical energy from changes of chemical potential during the intercalation/deintercalation of lithium ions at the positive and negative electrodes.

Lithium rechargeable batteries use a material that reversibly intercalates or deintercalates lithium ions during the charge and discharge reactions as an active material for positive and negative electrodes, and an organic electrolyte or a polymer electrolyte charged between the positive and negative electrodes.

The positive active material may include LiCoO₂, LiN₁₋ₓMₓO₂ (x is in a range of 0.95 to 1, and M is Al, Co, Ni, Mn, or Fe), LiMn₂O₄, or the like. The LiCoO₂ has high volumetric energy density and excellent high temperature characteristics, and particularly, an excellent cycle life characteristic at 60° C. and an excellent swelling characteristic at 90° C.

The negative active material may include a carbon-based material having small volume expansion and very low initial irreversible reaction, for example, natural graphite, artificial graphite, or the like.

The carbon-based material has irreversible capacity of about 10% as discharge capacity relative to initial charge capacity.

However, the carbon-based negative active material having capacity of about 370 to about 250 mAh/g has been replaced with a metal and a metal oxide-based negative active material having capacity of greater than and equal to about 1000 mAh/g, as a rechargeable lithium battery has needed more capacity.

This metal and metal oxide-based negative active material generates electrochemical energy through a chemical reaction with lithium, of which the initial charge reaction is an irreversible reaction.

However, this irreversible reaction brings about broken particles, detachment from a substrate, and the like due to physical stress according to volume expansion as well as formation of a stable compound (for example, Li₂O).

In addition, the irreversible reaction at a negative electrode may cause lithium loss from a positive active material during the initial term, and thus sharply decreases battery capacity during the charge and discharge, and also breaks positive active material particles and destroys their crystal structure due to excessive stress from the lithium loss.

Accordingly, disclosed is a method of preparing a positive active material by mixing a commercially-available layered material such as LiCoO₂ with Li₂NiO₂ with an orthorhombic Immm structure to suppress over-discharge of a rechargeable lithium battery and to simultaneously provide Li ions during the initial charge reaction.

However, this method has a problem that Ni²⁺ excessively existing on the surface of LiNiO₂ reacts with moisture in the air and produces impurities such as LiOH and Li₂CO₃, and thus deteriorates battery capacity, which is one of the problems of a compound including a lot of Ni.

In addition, the impurities produces a gas during the formation process when manufacturing a rechargeable lithium battery, and when a charged battery is stored at a high temperature of greater than or equal to 60° C., excessive swelling of the battery occurs.

In order to solve this problem, a method of coating the surface of LiNiO₂ with Al₂O₃ and the like has been suggested, but this causes an instability problem when a battery is stored in the air for a long time.

### SUMMARY OF THE INVENTION

One embodiment of the present invention provides a positive active material capable of providing lithium used for initial irreversible capacity, and thus improving performance and cycle life of a rechargeable lithium battery.

Another embodiment of the present invention provides a rechargeable lithium battery including the positive active material.

According to one embodiment of the present invention, a lithiated intercalation compound that can reversibly intercalate and deintercalate lithium and a positive active material for a rechargeable lithium battery including a metal oxide represented by the following Chemical Formula 1 are provided.

LiₓM_{y}M′_{1-y}O₄ [Chemical Formula 1]

In Chemical Formula 1,

M is selected from the group consisting of Co, Ni, Mn, Fe, and a combination thereof, M′ is selected from the group consisting of Co, Ni, Mn, Fe, Al, Mg, Zn, Ti, and a combination thereof, M and M′ are different from each other, 5.00≦x≦6.05, and 0≦y≦1.

The compound of the above Chemical Formula 1 may be selected from the group consisting of Li₆CoO₄, Li₆NiO₄, Li₆MnO₄, Li₆FeO₄, Li₅FeO₄, Li₆Co_{0.9}Al_{0.1}O₄, Li₆Ni_{0.9}Al_{0.1}O₄, Li₆Mn_{0.9}Al_{0.1}O₄, Li₅Fe_{0.9}Al_{0.1}O₄, Li₆Co_{0.5}Fe_{0.5}O₄, Li₆Ni_{0.5}Fe_{0.5}O₄, Li₆Ni_{0.9}Al_{0.1}O₄, and a mixture thereof, and in one embodiment, the compound is preferably orthorhombic Li₆CoO₄ having an anti-fluorite structure.

The compound of the above Chemical Formula 1 may have a particle with an average particle diameter ranging from about 1 to about 20 μm.

The compound of the above Chemical Formula 1 may have purity ranging from about 99.5 to about 99.9%.

The compound of the above Chemical Formula 1 may be prepared by mixing a lithium compound, a metal M-containing compound, and a metal M′-containing compound and heat-treating the mixture under an inert atmosphere at a temperature ranging from about 700 to about 900° C., wherein the metal M is selected from the group consisting of Co, Ni, Mn, Fe, and a combination thereof, the metal M′ is selected from the group consisting of Co, Ni, Mn, Fe, Al, Mg, Zn, Ti, and a combination thereof, and M and M′ are different from each other.

The lithiated intercalation compound may be selected from the group consisting of the compounds represented by the following Chemical Formulae 2 to 7.

Liₐ(M₁)ₚ(M₂)_{q}(M₃)_{1-p-q}O_{b} [Chemical Formula 2]

LiₓCo_{1-y}(M₄)_{y}D₂ [Chemical Formula 3]

LiₓCo_{1-y}(M₄)_{y}O_{2-z}X_{z} [Chemical Formula 4]

LiₓCo_{1-y}Ni_{y}O_{2-z}X_{z} [Chemical Formula 5]

LiₓCo_{1-y-z}Ni_{y}(M₄)_{z}Dw [Chemical Formula 6]

LiₓCo_{1-y-z}Ni_{y}(M₄)_{z}O_{2-w}X_{w} [Chemical Formula 7]

In Chemical Formulae 2 to 7,

M₁, M₂, and M₃ are independently selected from the group consisting of Al, Co, Fe, Mg, Mn, Ni, Ti, and a combination thereof,

M₄ is selected from the group consisting of Al, Co, Cr, Ni, Fe, Mg, Mn, Sr, V, a rare earth element, and a combination thereof,

D is an element selected from the group consisting of O, F, S, P, and a combination thereof,

X is an element selected from the group consisting of F, S, P, and a combination thereof,

0.99≦a≦1.1, 2≦b≦4, 0≦p≦0.9, 0≦q≦0.9,

0.9≦x≦1.1, 0≦y≦0.5, 0≦z≦0.5, and 0≦w≦2.

The lithiated intercalation compound and a compound represented by Chemical Formula 1 may be included in a weight ratio of about 80:20 to about 97:3 and specifically, about 85:15 to about 96:4.

According to another embodiment of the present invention, a rechargeable lithium battery that includes a positive electrode including the positive active material, a negative electrode including a negative active material, and an electrolyte is provided.

Hereinafter, further embodiments of this disclosure will be described in detail.

Therefore, the positive active material provides lithium during the initial irreversible reaction of a negative active material, and thus may increase charge capacity of a battery, decrease its irreversible capacity, and improve its cycle life.

### BRIEF DESCRIPTION OF THE DRAWINGS

FIG. 1A is a 5000×SEM photograph showing Li₆CoO₄ according to Example 1 using a scanning electron microscope (SEM), while FIG. 1B is a 30,000×SEM photograph thereof.

FIG. 2A is a 2000×SEM photograph showing LiCoO₂ according to Example 1 using a scanning electron microscope, while FIG. 2B is a 16,000×SEM photograph thereof.

FIG. 3A is a 1000×SEM photograph of a positive active material (a mixture of LiCoO₂ and Li₆CoO₄ mixed in a weight ratio of 85:15) according to Example 3 using a scanning electron microscope, while FIG. 3B is a 5000×SEM photograph thereof.

FIG. 4A is a 10,000× photograph of the surface of Li₆CoO₄ particles using a scanning electron microscope after charging and discharging a cell including the active material according to Example 3, 10 times.

FIG. 4B is a photograph (30,000×) of the surface of LiCoO₂ particles using a scanning electron microscope after charging and discharging a cell including the active material according to Example 3, 10 times.

FIG. 4C is a photograph (30,000×) of the surface of LiCoO₂ using a scanning electron microscope after charging and discharging a cell including the positive active material according to Comparative Example 1, 10 times.

FIG. 4D is a photograph (30,000×) of the surface of LiCoO₂ using a scanning electron microscope after charging and discharging a cell including the positive active material according to Comparative Example 2, 10 times.

FIG. 4E is a photograph (10,000×) of the surface of Li₆CoO₄ using a scanning electron microscope after charging and discharging a half cell including the positive active material according to Comparative Example 3 once.

FIG. 4F is a photograph (30,000×) of the surface of Li₆CoO₄ using a scanning electron microscope after charging and discharging a half cell including the positive active material according to Comparative Example 3 once.

FIG. 5 is a graph showing the X-ray diffraction (XRD) pattern of Li₆CoO₄ according to Example 1.

FIG. 6 is a graph showing the initial charge and discharge characteristics of a cell including the positive active material according to Example 1.

FIG. 7 is a graph showing the initial charge and discharge characteristics of a half cell respectively including natural graphite and nano-Si/SiOₓ (1≦x≦2) as a negative active material.

FIG. 8A is a graph showing the initial charge and discharge characteristics of a cell according to Comparative Example 1.

FIG. 8B is a graph showing the initial charge and discharge characteristics of a cell according to Comparative Example 2.

FIG. 9 is a graph showing the initial charge and discharge characteristics of each cell according to Examples 1 to 3.

FIG. 10 is a graph showing the charge and discharge characteristics of a cell according to Example 3 after 1 and 2 cycles.

### DETAILED DESCRIPTION OF THE EMBODIMENTS

Exemplary embodiments of this disclosure will hereinafter be described in detail. However, these embodiments are only exemplary, and this disclosure is not limited thereto.

The present invention provides a positive active material prepared by mixing a lithiated intercalation compound capable of reversibly intercalating and deintercalating lithium with a compound excessively including lithium to easily provide lithium needed for the irreversible chemical/physical reaction at a negative electrode during the initial charge reaction, and thus increase charge capacity of a battery, decrease its irreversible capacity, and resultantly improve its cycle life.

In other words, a positive active material according to one embodiment of the present invention includes a lithiated intercalation compound capable of reversibly intercalating and deintercalating lithium, and a metal oxide represented by the following Chemical Formula 1.

LiₓM_{y}M′_{1-y}O₄ [Chemical Formula 1]

In Chemical Formula 1,

M is selected from the group consisting of Co, Ni, Mn, Fe, and a combination thereof, M′ is selected from the group consisting of Co, Ni, Mn, Fe, Al, Mg, Zn, Ti, and a combination thereof, M and M′ are different from each other, 5.00≦x≦6.05, and 0≦y≦1.

In the above Chemical Formula 1, when the x and y are within the range, the active material may bring about excellent capacity characteristics and stability. In particular, when the x is less than or equal to about 5.00, a positive active material may have a structural variation and thus deteriorate capacity characteristics of a battery, while when the x is greater than or equal to 6.05, the compound of the above Chemical Formula 1 may have an unstable surface in air due to formation of non-reacted Li₂O and thus generate gas and precipitate lithium at a high temperature. Accordingly, the x may be in a range of 5.00≦x≦6.00 considering stability and prevention of formation of non-reacted Li₂O.

The compound of the above Chemical Formula 1 may be selected from the group consisting of Li₆CoO₄, Li₆NiO₄, Li₆MnO₄, Li₆FeO₄, Li₅FeO₄, Li₆Co_{0.9}Al_{0.1}O₄, Li₆Ni_{0.9}Al_{0.1}O₄, Li₆Mn_{0.9}Al_{3.1}O₄, Li₅Fe_{0.9}Al_{0.1}O₄, Li₆Co_{0.5}Fe_{0.5}O₄, Li₆Ni_{0.5}Fe_{0.5}O₄, Li₆Ni_{0.9}Al_{0.1}O₄, and a mixture thereof, and in one embodiment, orthorhombic Li₆CoO₄ having an anti-fluorite structure is more preferable.

The compound of the above Chemical Formula 1 may be prepared in a common method, in particular, a method of mixing a lithium compound, a metal M-containing compound, and a metal M′-containing compound and heat-treating the mixture under an inert atmosphere at a temperature ranging from about 700 to about 900° C.

The lithium compound may be selected from the group consisting of a lithium-containing oxide such as Li₂O, a lithium-containing hydroxide such as LiOH, a lithium-containing carbonate salt such as Li₂CO₃, and a mixture thereof, and in particular, a lithium compound with purity ranging from about 99.5 to about 99.9%, which may decrease the amount of impurities in a final compound.

The metal M-containing compound may be an oxide including a metal selected from the group consisting of Co, Ni, Mn, Fe, and a combination thereof, a metal salt, hydrates thereof, and the like. Example of the Co-containing compound may be selected from the group consisting of CoO, Co₃O₄, Co(OH)₂, Co(OH)₃, Co(NO₃)₂.xH₂O (1≦x≦7), Co(COOCH₃)₂, and a mixture thereof. Example of the Ni-containing compound may be selected from the group consisting of NiO, Ni₃O₄, Ni(OH)₂, Ni(OH)₃, Ni(NO₃)₂.xH₂O (1≦x≦7), Ni(COOCH₃)₂, and a mixture thereof. Example of the Mn-containing compound may be selected from the group consisting of MnO, Mn₂O₃, Mn(OH)₂, Mn(OH)₃, Mn(NO₃)₂.xH₂O (1≦p≦7), Mn(COOCH₃)₂, and a mixture thereof. Example of the Fe-containing compound may be selected from the group consisting of Fe₂O₃, Fe(OH)₂, Fe(OH)₃, Fe(NO₃)₂.xH₂O (1≦p≦7), Fe(COOCH₃)₂, and a mixture thereof.

The metal M′-containing compound may include an oxide including a metal selected from the group consisting of Co, Ni, Mn, Fe, Al, Mg, Zn, Ti, and a combination thereof, a metal salt, hydrates thereof, and the like. Examples of the metal salt may include hydroxides, nitrates, acetates, and the like. The metal salt may be appropriately selected depending on a metal.

However, the metal M-containing compound and the metal M′-containing compound may respectively include different metals M and M′.

The lithium compound and the metal-containing compound are mixed in an appropriate mole ratio considering the amounts of lithium and a metal in a final compound represented by Chemical Formula 1.

The lithium compound and the metal-containing compound may be mixed in a common method such as a dry or wet method and the like.

Then, the mixture may be heat-treated under an inert atmosphere such as nitrogen, argon, and the like at a temperature ranging from about 700 to about 900° C., in particular, about 700 to about 800° C., for about 2 hours to about 20 hours. Under the above conditions, the compound of Chemical Formula 1 may have high purity and a high yield.

The compound of the above Chemical Formula 1 may have purity within about 99.5 to about 99.9%. When the compound of Chemical Formula 1 has purity within the range, it includes fewer impurities such as Li₂O, Co, and the like, and thus may provide more lithium ions.

The compound of the above Chemical Formula 1 may include particles with an average particle diameter of about 1 to about 20 μm. When the compound of the above Chemical Formula 1 has a particle diameter within the range, the compound may be easily decomposed and sufficiently provide lithium without increasing resistance.

The lithiated intercalation compound may have no particular limit as far as being used for a positive active material for a rechargeable lithium battery. In particular, the lithiated intercalation compound may be selected from the group consisting of compounds represented by the following Chemical Formulae 2 to 7.

Liₐ(M₁)ₚ(M₂)_{q}(M₃)_{1-p-q}O_{b} [Chemical Formula 2]

LiₓCo_{1-y}(M₄)_{y}D₂ [Chemical Formula 3]

LiₓCo_{1-y}(M₄)_{y}O_{2-z}X_{z} [Chemical Formula 4]

LiₓCo_{1-y}Ni_{y}O_{2-z}X_{z} [Chemical Formula 5]

LiₓCo_{1-y-z}Ni_{y}(M₄)_{z}Dw [Chemical Formula 6]

LiₓCo_{1-y-z}Ni_{y}(M₄)_{z}O_{2-w}X_{w} [Chemical Formula 7]

In the above Chemical Formulae 2 to 7,

M₁, M₂, and M₃ are independently selected from the group consisting of Al, Co, Fe, Mg, Mn, Ni, Ti, and a combination thereof,

M₄ is selected from the group consisting of Al, Co, Cr, Ni, Fe, Mg, Mn, Sr, V, a rare earth element, and a combination thereof,

D is an element selected from the group consisting of O, F, S, P, and a combination thereof,

X is an element selected from the group consisting of F, S, P, and a combination thereof,

0.99≦a≦1.1, 2≦b≦4, 0≦p≦0.9, 0≦q≦0.9,

0.9≦x≦1.1, 0≦y≦0.5, 0≦z≦0.5, and 0≦w≦2.

In one embodiment, the lithiated intercalation compound may be selected from the group consisting of LiCoO₂, LiMnO₂, LiCo_{1/3}Ni_{1/3}Mn_{1/3}O₂, LiFeO₄, LiMnO₄, LiCoO₄, and a mixture thereof, but is not limited thereto.

The lithiated intercalation compound may have a particle phase, and the particle has no particular limit in size.

The lithiated intercalation compound may be mixed with the compound of Chemical Formula 1 in various weight ratios depending on irreversible capacity of a negative electrode, particularly, in a weight ratio ranging from about 80:20 to about 97:3, more particularly, in a weight ratio ranging from about 85:15 to about 96:4, and much more particularly, in a weight ratio ranging from about 95:5 to about 96:4. For example, when a negative active material with irreversible capacity of greater than or equal to about 40% such as silicon, silicon oxide, and the like is used, the lithiated intercalation compound and the compound of Chemical Formula 1 may be mixed in a weight ratio ranging from about 80:20 to about 90:10. When a carbon-based material with irreversible capacity of less than or equal to 10% is used as a negative active material, the lithiated intercalation compound and the compound of Chemical Formula 1 may be mixed in a range of about 95:5 to about 97:3. When the lithiated intercalation compound and the compound of Chemical Formula 1 are mixed within the range, a negative electrode may be easily controlled regarding irreversible capacity and suppressed from increasing resistance.

The positive active material may be prepared by mixing the lithiated intercalation compound and the compound of Chemical Formula 1.

Since the lithiated intercalation compound is physically mixed with the compound of Chemical Formula 1, the compound of the above Chemical Formula 1 may easily provide lithium required due to an irreversible physical/chemical reaction at a negative electrode during the initial charge reaction, and thus increase charge capacity and decrease capacity, improving the cycle life. As a result, a positive active material of the present invention may be usefully applied to a positive electrode for an electrochemical cell such as a rechargeable lithium battery.

According to another embodiment of the present invention, a rechargeable lithium battery includes a positive electrode including the positive active material, a negative electrode including a negative active material, and an electrolyte.

The positive electrode includes a current collector and a positive active material layer disposed on the current collector.

The current collector may include copper or stainless steel surface-treated with carbon, nickel, or titanium, or a polymer substrate coated with a conductive metal and the like as well as stainless steel, aluminum, nickel, iron, copper, titanium, carbon, or a conductive resin. The current collector has no particular limit in shape, but may have a shape such as flake, plate, mesh (grid), and foam (sponge), and in particular, a sponge shape with excellent current collecting efficiency.

The positive active material layer includes a conductive material and a binder along with the positive active material.

The positive active material is the same as aforementioned, and may be used in an appropriate amount depending on irreversible capacity of a negative active material. In particular, the positive active material may be used in an amount of about 5 to about 20 wt % based on the entire weight of a positive active material layer, and can thus easily control irreversible capacity of a negative electrode without increasing resistance of a battery and deteriorating electrode density.

The conductive material may include a carbon-based material such as natural graphite, artificial graphite, carbon black, acetylene black, ketjen black, carbon fiber, and the like; a metal powder or a metal fiber of copper, nickel, aluminum, silver, and the like; or a conductive polymer material such as a polyphenylene derivative. These may be used singularly or as a mixture of two or more.

The binder may be selected from the group consisting of a vinylidene fluoride/hexafluoropropylene copolymer, polyvinylidene fluoride, polyacrylonitrile, polymethylmethacrylate, polytetrafluoroethylene, and a mixture thereof.

The positive electrode may be fabricated by mixing a positive active material, a conductive material, and a binder in a solvent to prepare a composition for a positive active material layer, then coating the composition on a current collector and drying it; or casting the composition on a separate supporter, peeling a film from the supporter, and laminating the film on an aluminum current collector.

The solvent may include N-methylpyrrolidone, acetone, tetrahydrofuran, decane, and the like. The composition for a positive active material may include a conductive material, a binder, and a solvent in an amount commonly used for a rechargeable lithium battery.

The negative electrode includes a current collector and a negative active material layer disposed on the current collector, like the positive electrode.

The negative active material layer includes a negative active material, a binder, and optionally a conductive agent.

The negative active material includes a material being capable of reversibly intercalating/deintercalating lithium ions, a lithium metal, an alloy of a lithium metal, a material being capable of doping and dedoping lithium, or a transition metal oxide.

In one embodiment, the negative active material may include a lithium metal, a lithium alloy, coke, artificial graphite, natural graphite, an organic polymer compound combustion product, carbon fiber, Si, SiOₓ, Sn, SnO₂, and the like.

The binder and conductive material are the same as described for the positive electrode.

Likewise, the negative electrode may be fabricated by mixing a negative active material, a binder, a solvent, and selectively a conductive material to prepare a composition for a negative active material, then directly coating the composition on a copper current collector or drying it, or casting the composition on a supporter, peeling a film from the supporter, and laminating the film on a copper current collector.

The rechargeable lithium battery is charged with a non-aqueous electrolyte including a lithium salt dissolved in a non-aqueous organic solvent, a solid electrolyte, or the like.

In the non-aqueous electrolyte, the non-aqueous organic solvent has no particular limit but may include a cyclic carbonate such as ethylene carbonate, propylene carbonate, butylene carbonate, vinylene carbonate, and the like; a linear carbonate such as dimethyl carbonate, methylethyl carbonate, diethyl carbonate, and the like; esters such as methyl acetate, ethyl acetate, propyl acetate, methyl propionate, ethyl propionate, γ-butyrolactone, and the like; ethers such as 1,2-dimethoxyethane, 1,2-diethoxyethane, tetrahydrofuran, 1,2-dioxane, 2-methyltetrahydrofuran, and the like; nitriles such as acetonitrile; and amides such as dimethyl formamide, and the like. These may be used singularly or as a mixture of two or more. In one embodiment, a mixed solvent of a cyclic carbonate and a linear carbonate may be preferably used.

The lithium salt may include at least one selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiCl, and LiI. The lithium salt may be used at a concentration of about 0.1 M to about 2.0 M. Within the above concentration range, the electrolyte has an appropriate viscosity and thus excellent electrolyte performance, and effective transfer of lithium ions may be realized.

The solid electrolyte may include a gel-phased polymer electrolyte prepared by impregnating a polymer electrolyte such as polyethylene oxide, polyacrylonitrile, and the like in an electrolyte solution, or an inorganic solid electrolyte such as LiI, Li₃N, and the like.

The rechargeable lithium battery may further include a separator stopping electron transfer between negative and positive electrodes but transferring lithium ions.

The separator has no particular limit as far as commonly used for a rechargeable lithium battery, and may include, for example, polyethylene, polypropylene, polyvinylidene fluoride, or a multilayer of two or more thereof, a polyethylene/polypropylene separator, a polyethylene/polypropylene/polyethylene separator, a polypropylene/polyethylene/polypropylene separator, and the like.

The rechargeable lithium battery according to the present invention may have various shapes such as a coin-type, a button-type, a sheet-type, a lamination-type, a cylinder, a plate, a prism, and the like, and may be appropriately applied depending on a desired purpose.

Hereinafter, the embodiments are illustrated in more detail with reference to examples. However, the following are exemplary embodiments and are not limiting.

### Example 1

Li₂CO₃ with purity of 99.9% was fired for thermal decomposition at 700° C. under an oxygen atmosphere, preparing Li₂O with purity of 99.9%. 16 g of Li₂O was uniformly mixed with 11 g of CoO (average particle diameter: 10 μm) with an automatic mixer. This mixture was fired at 700° C. under a pure N₂ atmosphere for 12 hours, preparing Li₆CoO₄ with purity of 99% (average particle diameter: about 20 μm).

The Li₆CoO₄ was mixed with LiCoO₂ having an average particle diameter of 10 μm in a weight ratio of 5:95, preparing a positive active material.

On the other hand, a polyvinylidene fluoride binder was dissolved in a N-methyl-2-pyrrolidone solvent. The positive active material and a carbon black conductive material were added to the solution, preparing a positive active material slurry. Herein, the positive active material, the conductive material, and the binder were mixed in a weight ratio of 80:10:10. The slurry was coated on an Al foil and dried at 130° C. for 20 minutes, fabricating a positive electrode.

In addition, a Si/SiOₓ nanomixture with an average a particle diameter of about 50 nm as a negative active material was mixed with a polyvinylidene fluoride binder with a weight ratio of 92:8 in N-methyl-2-pyrrolidone, preparing a negative active material slurry. This negative active material slurry was coated on a Cu foil and dried, fabricating a negative electrode.

The positive and negative electrodes and a liquid electrolyte including HF in an amount of less than or equal to 20 ppm (in which 1.15 M LiPF₆ was dissolved in an ethylene carbonate/dimethyl carbonate/diethyl carbonate mixed solution in a volume ratio of 3/4/3, Techno Semichem Co., Ltd.) were combined, fabricating a coin cell with a CR2016 size. Herein, the positive and negative electrodes had an N/P (negative capacity/positive capacity) ratio of 1.05:1.

### Example 2

Li₂CO₃ with purity of 99.9% was fired for thermal decomposition at 700° C. under an oxygen atmosphere, preparing Li₂O with purity of 99.9%. 16 g of the Li₂O was uniformly mixed with 11 g of CoO (average particle diameter of 10 μm) using an automatic mixer. This mixture was fired at 700° C. under a pure N₂ atmosphere for 12 hours, preparing Li₆CoO₄ (average particle diameter: about 20 μm) with purity of 99%.

The Li₆CoO₄ was mixed with LiCoO₂ having an average particle diameter of 10 μm in a weight ratio of 10:90, preparing a positive active material.

The positive active material and a carbon black conductive material were added to a solution prepared by dissolving a polyvinylidene fluoride binder in an N-methyl-2-pyrrolidone solvent, preparing a positive active material slurry. Herein, the positive active material, the conductive material, and the binder were mixed in a weight ratio of 80:10:10. The slurry was coated on an Al foil and dried at 130° C. for 20 minutes, fabricating a positive electrode.

On the other hand, a negative active material slurry was prepared by mixing a Si/SiOₓ nanomixture with an average a particle diameter of about 50 nm as a negative active material and a polyvinylidene fluoride binder in a weight ratio of 92:8 in N-methyl-2-pyrrolidone. The negative active material slurry was coated on a Cu foil, fabricating a negative electrode.

The positive and negative electrodes and a liquid electrolyte including HF in an amount of less than or equal to 20 ppm (in which 1.15 M LiPF₆ was dissolved in an ethylene carbonate/dimethyl carbonate/diethyl carbonate mixed solution in a volume ratio of 3/4/3, Techno Semichem Co., Ltd.) were combined, fabricating a coin cell with a CR2016 size. Herein, the positive and negative electrode had an N/P capacity ratio of 1.05:1.

### Example 3

Li₂CO₃ with purity of 99.9% was fired for thermal decomposition at 700° C. under an oxygen atmosphere, preparing Li₂O with purity of 99.9%. 16 g of the Li₂O was uniformly mixed with 11 g of CoO (average particle diameter of 10 μm) with an automatic mixer. This mixture was fired at 700° C. under a pure N₂ atmosphere for 12 hours, preparing Li₆CoO₄ with purity of 99% (average particle diameter: about 20 μm).

The Li₆CoO₄ was mixed with LiCoO₂ having an average particle diameter of 10 μm in a weight ratio of 15:85, preparing a positive active material.

The positive active material and a carbon black conductive material were added to a solution prepared by dissolving a polyvinylidene fluoride binder in an N-methyl-2-pyrrolidone solvent, preparing a positive active material slurry. Herein, the positive active material, the conductive material, and the binder were mixed in a weight ratio of 80:10:10. The slurry was coated on an Al foil and dried at 130° C. for 20 minutes, fabricating a positive electrode.

On the other hand, a negative active material slurry was prepared by mixing a Si/SiOₓ (1≦x≦2) nanomixture having an average particle diameter of about 50 nm as a negative active material and a polyvinylidene fluoride binder in a weight ratio of 92:8 in N-methyl-2-pyrrolidone. This negative active material slurry was coated on a Cu foil, fabricating a negative electrode.

The positive and negative electrodes and a liquid electrolyte including HF in an amount of less than or equal to 20 ppm (in which 1.15 M LiPF₆ was dissolved in an ethylene carbonate/dimethyl carbonate/diethyl carbonate mixed solution in a volume ratio of 3/4/3, Techno Semichem Co., Ltd.) were combined, fabricating a coin cell with a CR2016 size. Herein, the positive and negative electrodes had an N/P capacity ratio of 1.05:1.

### Comparative Example 1

A rechargeable lithium battery was fabricated according to the same method as Example 1, except for using LiCoO₂ with an average particle diameter of 10 μm as a positive active material.

### Comparative Example 2

A rechargeable lithium battery was fabricated according to the same method as Example 1, except for using LiCoO₂ with an average a particle diameter of 10 μm s a positive active material and natural graphite as a negative active material.

### Comparative Example 3

A rechargeable lithium battery was fabricated according to the same method as Example 1, except for using Li₆CoO₄ with an average a particle diameter of 20 μm as a positive active material and a lithium foil as a negative electrode, fabricating a 2016 coin-type half-cell.

### Experimental Example 1

### Examination of Positive Active Material

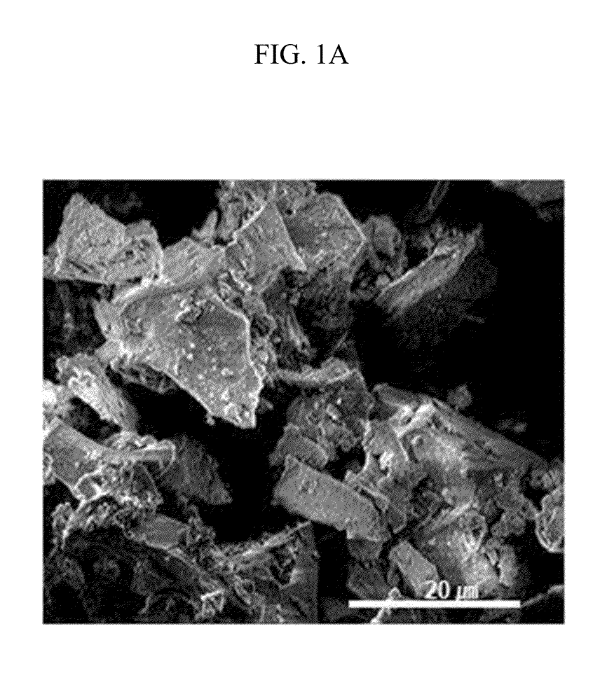

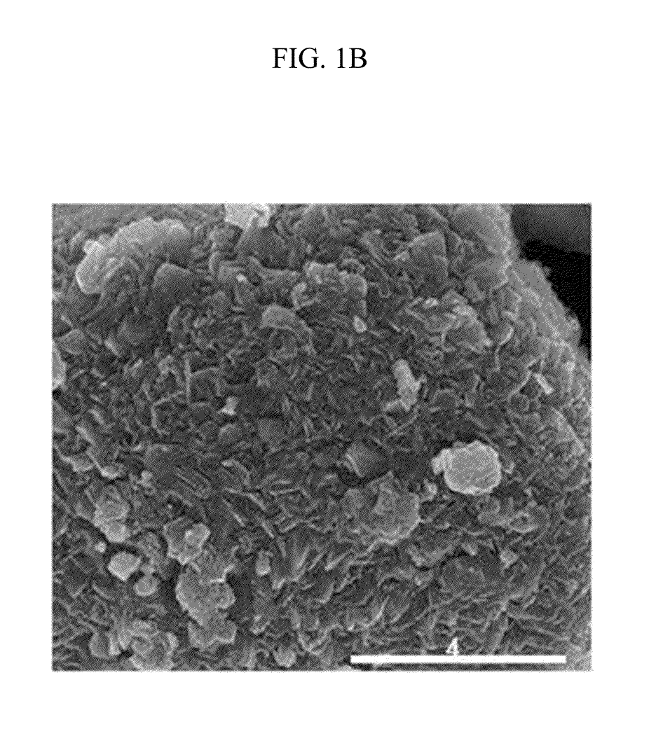

The Li₆CoO₄ according to Example 1 was enlarged by 5000 times and 30,000 times and examined with a scanning electron microscope. The results are provided in FIGS. 1A and 1B.

As shown in FIGS. 1A and 1B, the Li₆CoO₄ according to Example 1 had no particular shape and a particle size of about 20 μm.

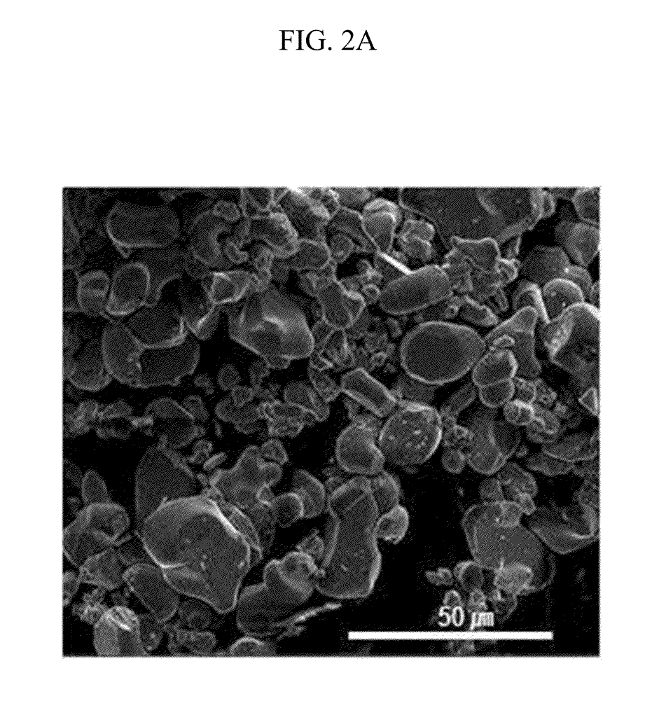

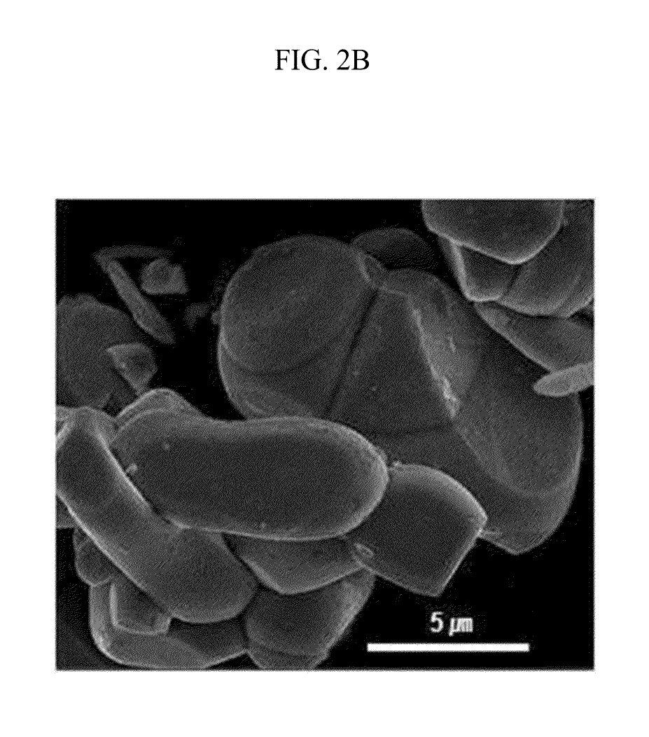

In addition, the LiCoO₂ according to Example 1 was respectively enlarged by 2000 times and 16,000 times and examined with a scanning electron microscope. The results are provided in FIGS. 2A and 2B.

As shown in FIGS. 2A and 2B, the LiCoO₂ according to Example 1 had a particle diameter of about 10 μm, and in addition, an easily observable smooth stream-line type surface.

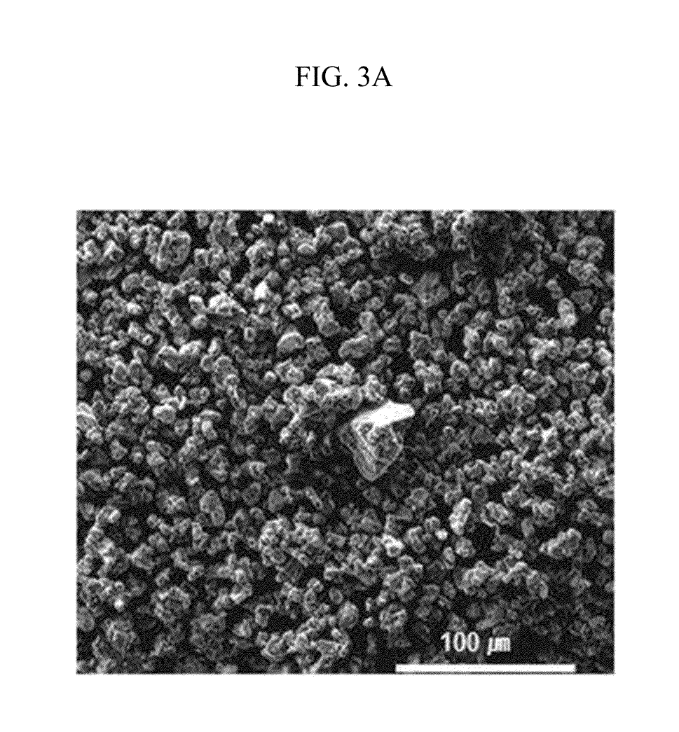

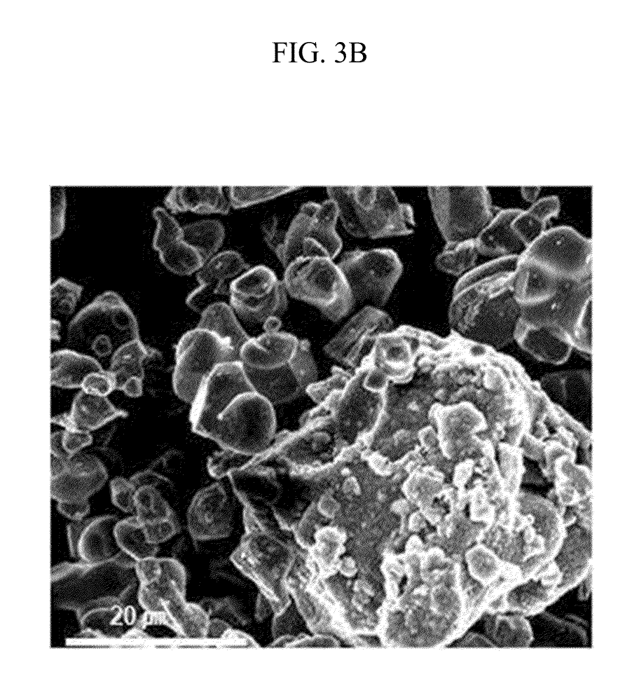

Furthermore, the positive active material according to Example 3 was respectively enlarged by 1000 times and 5000 times and examined with a scanning electron microscope. The results are provided in FIGS. 3A and 3B.

As shown in FIGS. 3A and 3B, the positive active material according to Example 3 was prepared by simply mixing Li₆CoO₄ and LiCoO₂. In addition, when Li₆CoO₄ was included in various weight ratios according to Examples 1 to 3, the active materials had no chemical/physical change.

### Experimental Example 2

### Positive Active Material Change after Charge and Discharge

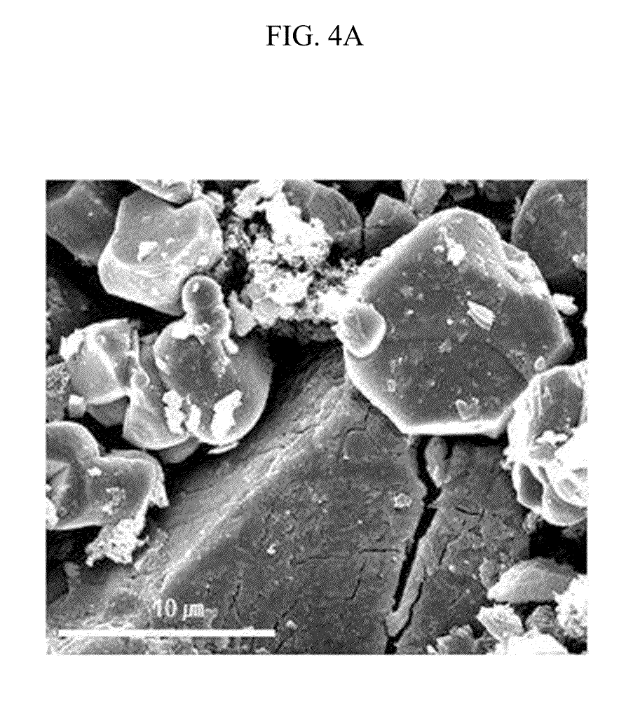

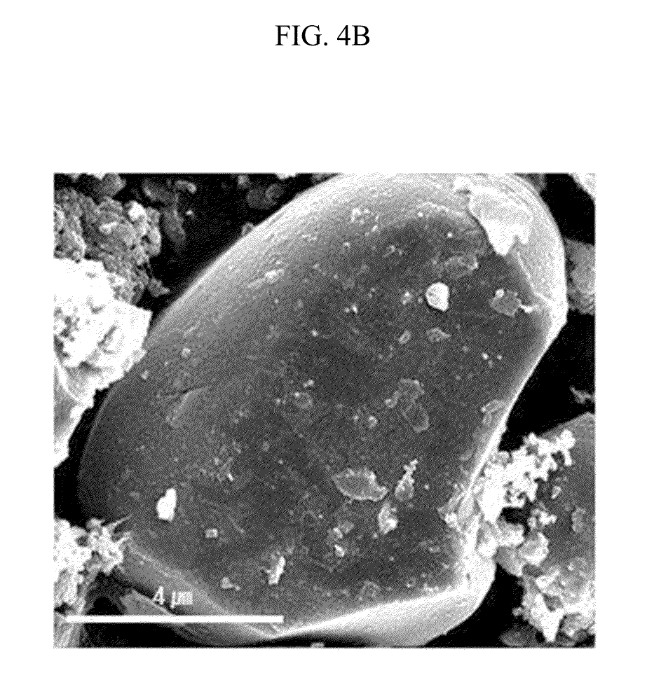

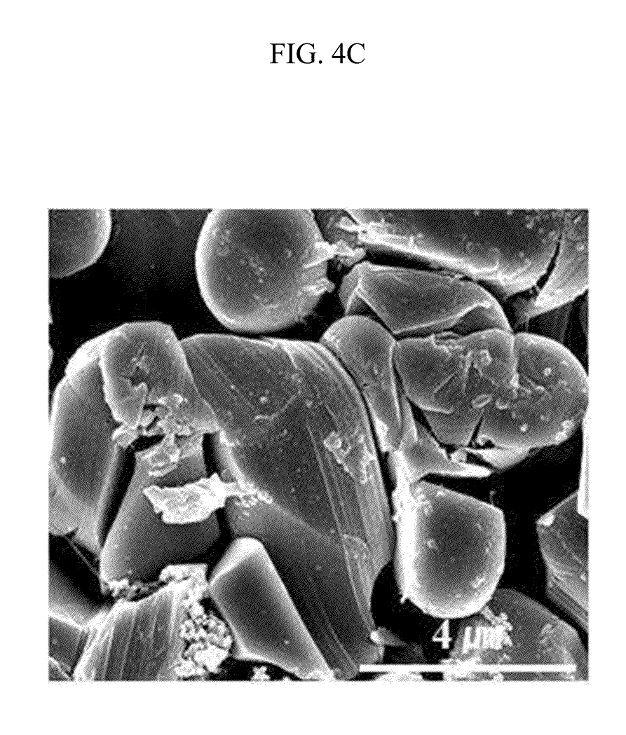

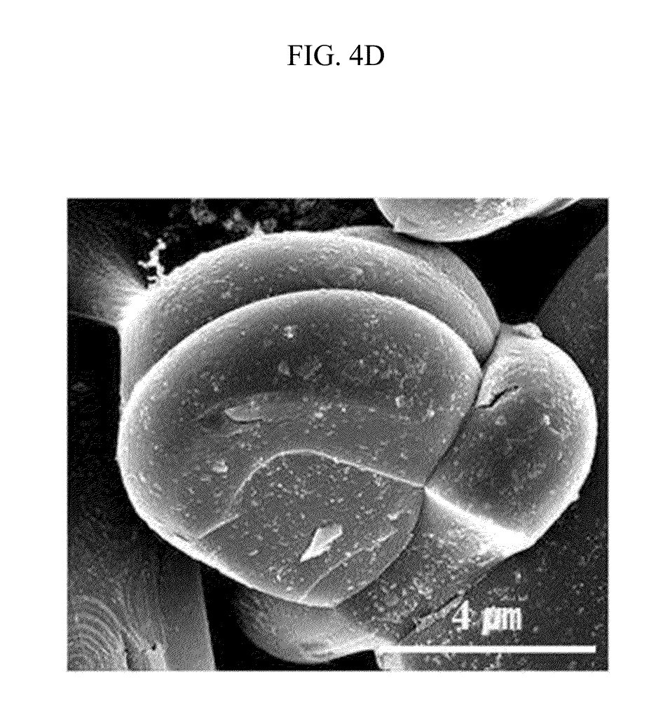

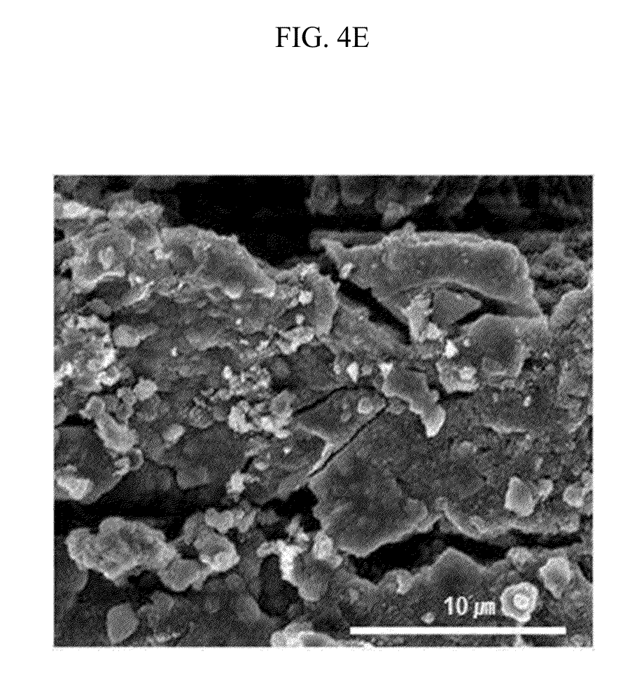

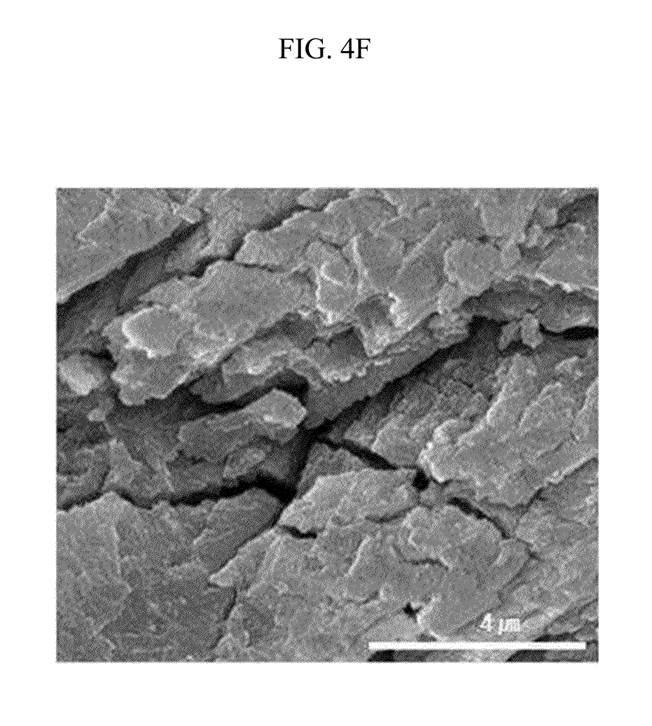

The rechargeable lithium battery according to Example 3 was charged and discharged ten times from 3.0 to 4.3 V, and the surface of Li₆CoO₄ and LiCoO₂ particles were examined with a scanning electron microscope. The results are respectively provided in FIG. 4A (10,000×) and FIG. 4B (30,000×).

The rechargeable lithium batteries according to Comparative Examples 1 and 2 were charged and discharged under the same conditions, and the surface of each active material was examined with a scanning microscope. The half-cell according to Comparative Example 3 was charged and discharged once under the same conditions, and the surface of the active material after one charge and discharge was examined with a scanning electron microscope. The results are provided in FIGS. 4C to 4F.

FIG. 4C is a SEM photograph (30,000×) showing the positive active material according to Comparative Example 1 after the charge and discharge, FIG. 4D is a SEM photograph (30,000×) showing the positive active material according to Comparative Example 2 after the charge and discharge, and FIG. 4E (10,000×) and FIG. 4F (30,000×) are photographs examining the positive active material according to Comparative Example 3 after the charge and discharge.

As shown in FIGS. 4A and 4B, the Li₆CoO₄ had a crack on the surface after the charge and discharge, while the LiCoO₂ had no change to the surface after the charge and discharge. As shown in FIG. 4C, the positive active material LiCoO₂ according to Comparative Example 1 had broken particles after the charge and discharge. On the contrary, the positive active material LiCoO₂ according to Comparative Example 2 shown in FIG. 4D had no particle change after the charge and discharge. As shown in FIGS. 4E and 4F, the positive active material Li₆CoO₄ according to Comparative Example 3 had a particle change after a one-time charge and discharge of a half-cell.

### Experimental Example 3

### XRD Pattern Examination of Li₆CoO₄

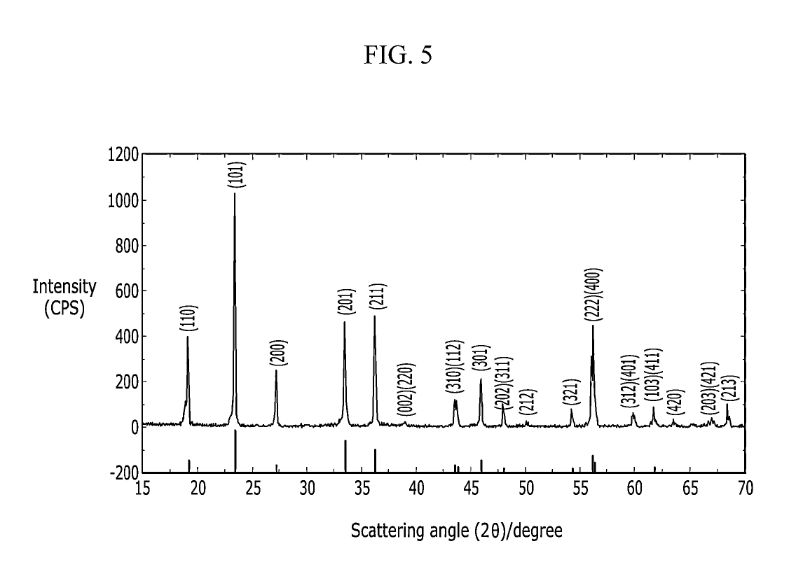

The Li₆CoO₄ according to Example 1 was analyzed regarding XRD using a Cu Kα ray. The results are provided in FIG. 5.

As shown in FIG. 5, pure Li₆CoO₄ having no impurity was produced, which might be classified into an orthorhombic phase with a space of P42/nmc.

### Experimental Example 4

### Initial Charge and Discharge Characteristic

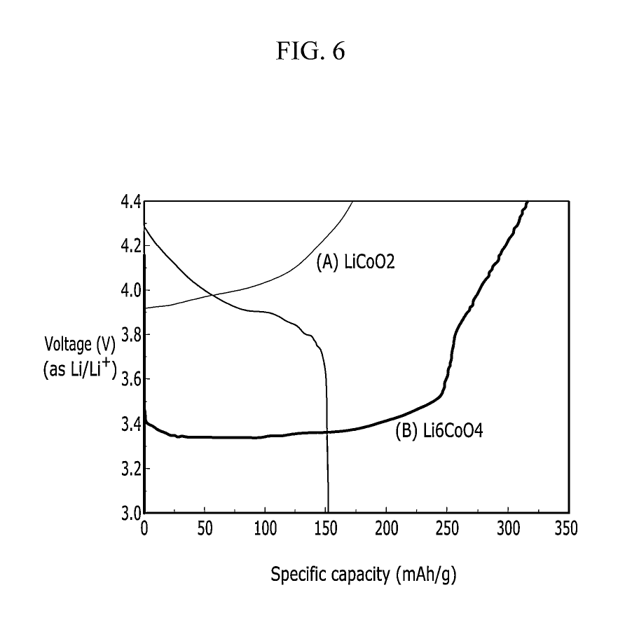

The positive active material (a mixture of LiCoO₂ and Li₆CoO₄ mixed in a weight ratio of 95:5) according to Example 1 and a lithium foil as a counter electrode were used to fabricate a 2016 coin-type half-cell. Herein, the 2016 coin-type half-cell was vacuum-sealed in a globe box filled with an inert gas in order to prevent oxidation and contamination of the 2016 coin-type half-cell. The 2016 coin-type half-cell was charged and discharged at 0.1 C to 4.4 V from 3.0 V and evaluated regarding initial charge and discharge characteristic. The results are provided in FIG. 6.

As shown in FIG. 6, in the positive active material, LiCoO₂ according to Example 1, had charge capacity of 173 mAh/g and discharge capacity of 153 mAh/g, and thus reversible capacity of 95%. In addition, Li₆CoO₄ had charge capacity of 317 mAh/g and discharge capacity of 1 mAh/g, and thus an irreversible electrochemical reaction of 100%.

### Experimental Example 5

### Charge and Discharge Characteristic Evaluation of Negative Electrode with Different Irreversible Capacity

A negative electrode was fabricated by mixing a Si/SiOₓ (1≦x≦2) nanomixture with a particle size of about 50 nm as a negative active material and polyvinylidene fluoride as a binder in a weight ratio of 92:8 to prepare a negative active material slurry, coating the negative active material slurry on a Cu foil, and drying it at 130° C. for 20 minutes.

Another negative electrode was fabricated according to the same method as aforementioned except for using natural graphite instead of the Si/SiOₓ (1≦x≦2) nanomixture as a negative active material.

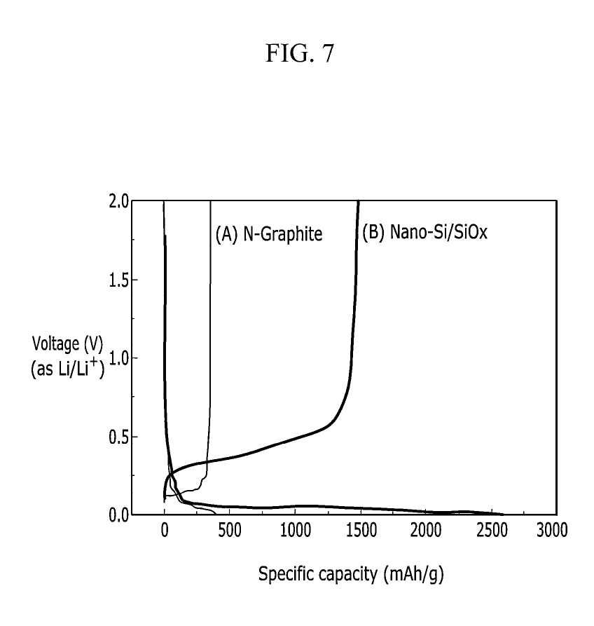

Each negative electrodes respectively including natural graphite and nano-Si/SiOx (1≦x≦2) as a negative active material and a lithium foil as a counter electrode were used to fabricate a half cell. The half cells were examined regarding initial charge and discharge characteristics. The results are provided in FIG. 7.

As shown in FIG. 7, natural graphite had charge capacity of 400 mAh/g and discharge capacity of 360 mAh/g, and thus low irreversible capacity of 10%. On the other hand, nano-Si/SiOx (1≦x≦2) had high irreversible capacity of 43%, and thus greater than or equal to 4 times the reversible capacity of about 1480 mAh/g than natural graphite.

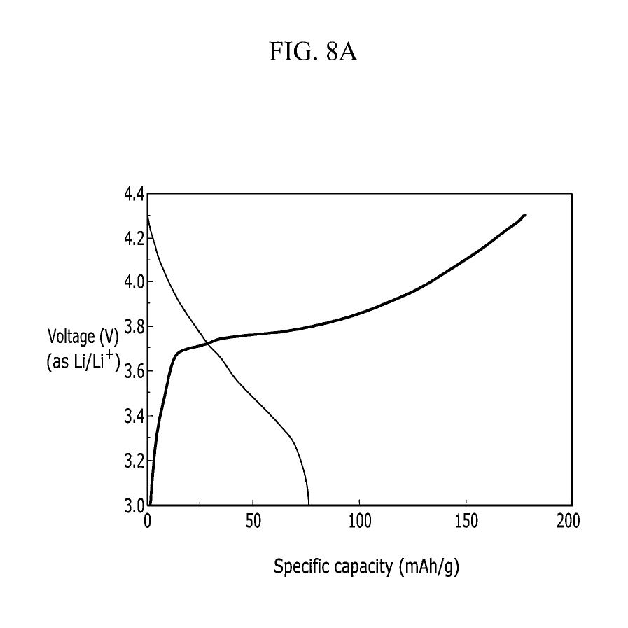

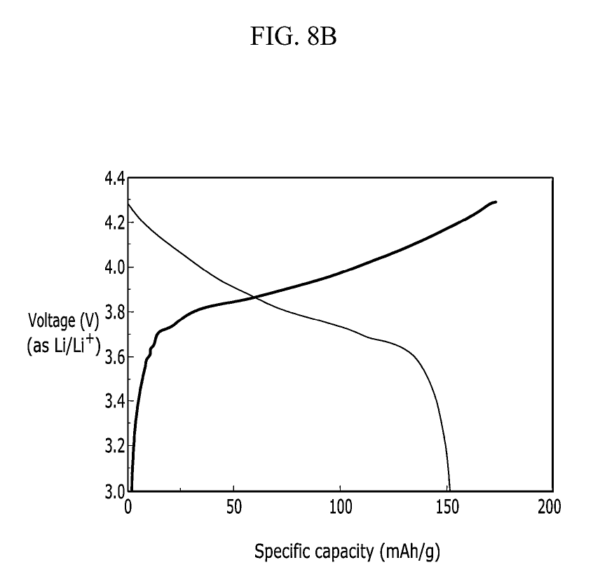

The cells according to Comparative Examples 1 and 2 were charged and discharged at 0.1 C and evaluated regarding charge and capacity characteristics. The results are provided in FIGS. 8A and 8B and the following Table 1.

TABLE 1

| | |
|---|---|
| Comparative | Comparative |
| Example 1 | Example 2 |

| | Charge | Discharge | Charge | Discharge |
|---|---|---|---|---|
| Cycle | capacity | capacity | capacity | capacity |
| number | (mAh/g) | (mAh/g) | (mAh/g) | (mAh/g) |
| 1 | 179 | 80 | 173 | 152 |
| 2 | 44 | 35 | 155 | 149 |
| 10 | — | — | 147 | 144 |

As shown in Table 1, the cell including natural graphite with low irreversible capacity as a negative active material according to Comparative Example 2 had irreversible capacity of 12%, which is similar to the result of a half cell. DeletedTexts

However, the cell using nano-Si/SiOx (1≦x≦2) with irreversible capacity of 43% as a negative active material according to Comparative Example 1 had very high initial irreversible capacity of 55%, since many lithium ions are used in an irreversible reaction, but the initial irreversible capacity sharply decreased as the charge and discharge cycles of the cell progressed.

### Experimental Example 6

### Charge and Discharge Characteristic Evaluation Depending on Li₆CoO₄ Additive

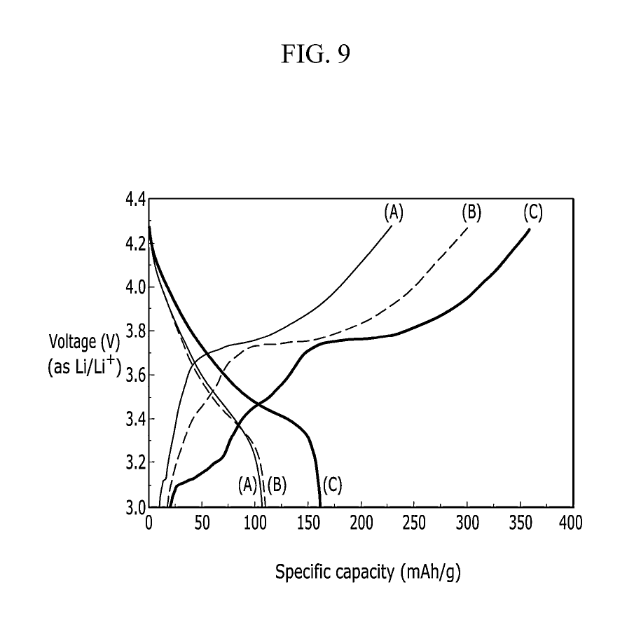

The rechargeable lithium batteries according to Examples 1 to 3 were respectively aged at 21° C. for 1 day and charged and discharged at 0.1 C from 3.0 V to 4.3 V. FIG. 9 shows charge and discharge curves of the rechargeable lithium batteries according to Examples 1 to 3. In FIG. 9, (a) indicates data of Example 1, (b) indicates data of Example 2, and (c) indicates data of Example 3.

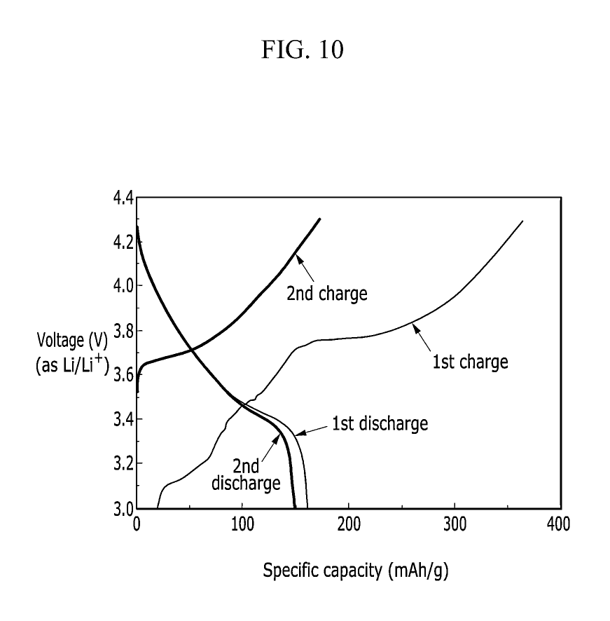

FIG. 10 is a graph showing charge and discharge characteristic results of the cell according to Example 3 after one and two cycles. The rechargeable lithium batteries according to Examples 1 to 3 were measured regarding charge capacity, discharge capacity, and irreversible capacity. The results are provided in the following Table 2.

TABLE 2

| | | | Irreversible capacity |
|---|---|---|---|
| | | | (relative to charge |
| | | | capacity of the |
| | Charge | Discharge | battery cell according |
| | capacity | capacity | to Comparative |
| | (mAh/g) | (mAh/g) | Example 2, 179 mAh/g) |
| Example 1 | 232 | 114 | 36% |
| Example 2 | 306 | 115 | 36% |
| Example 3 | 365 | 166 | 7% |
| Comparative | 173 | 80 | 56% |
| Example 1 | | | |
| Comparative | 179 | 152 | 12% |
| Example 2 | | | |

The irreversible capacity in Table 2 indicates irreversible capacity percentage calculated according to the following Equation 1.

100%−[(discharge capacity of cells according to Examples 1 to 3/charge capacity of a cell according to Comparative Example 2)*100] [Equation 1]

The irreversible capacity indicates a reversible ratio of initial charge capacity relative to discharge capacity. The cells according to Examples 1 to 3 used a Si/SiOₓ (1≦x≦2) nanomixture having high irreversible capacity as a negative active material and Li₆CoO₄ having high initial charge capacity but an irreversible reaction as a positive active material and thus a low reversible ratio of charge capacity relative to discharge capacity. However, since Li₆CoO₄ provides lithium used in an irreversible reaction at a negative electrode while LiCoO₂ as a positive active material completely participates in charge and discharge in the present invention, charge capacity of the cell according to Comparative Example 2 is comparable with discharge capacity of the cells according to Example 1 to 3.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A positive active material for a rechargeable lithium battery, comprising:
a lithiated intercalation compound capable of reversibly intercalating and deintercalating lithium; and
a metal oxide represented by the following Chemical Formula 1:
LiₓM_{y}M′_{1-y}O₄ [Chemical Formula 1]
wherein, in Chemical Formula 1,
M is selected from the group consisting of Co, Ni, Mn, Fe, and a combination thereof, M′ is selected from the group consisting of Co, Ni, Mn, Fe, Al, Mg, Zn, Ti, and a combination thereof, M and M′ are different from each other, 5.00≦x≦6.05, and 0≦y≦1.

2. The positive active material for a rechargeable lithium battery of claim 1, wherein the compound of the above Chemical Formula 1 is selected from the group consisting of Li₆CoO₄, Li₆NiO₄, Li₆MnO₄, Li₆FeO₄, Li₅FeO₄, Li₆Co_{0.9}Al_{0.1}O₄, Li₆Ni_{0.9}Al_{0.1}O₄, Li₆Mn_{0.9}Al_{0.1}O₄, Li₅Fe_{0.9}Al_{0.1}O₄, Li₆Co_{0.5}Fe_{0.5}O₄, Li₆Ni_{0.5}Fe_{0.5}O₄, Li₆Ni_{0.9}Al_{0.1}O₄, and a mixture thereof.

3. The positive active material of claim 1, wherein the compound represented by the above Chemical Formula 1 is orthorhombic Li₆CoO₄ having an anti-fluorite structure.

4. The positive active material of claim 1, wherein the compound of the above Chemical Formula 1 has a particle phase with an average particle diameter ranging from about 1 to about 20 μm.

5. The positive active material of claim 1, wherein the compound of the above Chemical Formula 1 has purity of about 99.5 to about 99.9%.

6. The positive active material of claim 1, wherein the compound of the above Chemical Formula 1 is prepared by mixing a lithium compound, a metal M-containing compound, and a metal M′-containing compound and heat-treating the mixture at an inert atmosphere ranging from about 700 to about 900° C.,
wherein the metal M is selected from the group consisting of Co, Ni, Mn, Fe, and a combination thereof, the metal M′ is selected from the group consisting of Co, Ni, Mn, Fe, Al, Mg, Zn, Ti, and a combination thereof, and M and M′ are different from each other.

7. The positive active material for a rechargeable lithium battery of claim 1, wherein the lithiated intercalation compound may be selected from the group consisting of the compounds represented by the following Chemical Formulae 2 to 7:
Liₐ(M₁)ₚ(M₂)_{q}(M₃)_{1-p-q}O_{b} [Chemical Formula 2]
LiₓCo_{1-y}(M₄)_{y}D₂ [Chemical Formula 3]
LiₓCo_{1-y}(M₄)_{y}O_{2-z}X_{z} [Chemical Formula 4]
LiₓCo_{1-y}Ni_{y}O_{2-z}X_{z} [Chemical Formula 5]
LiₓCo_{1-y-z}Ni_{y}(M₄)_{z}Dw [Chemical Formula 6]
LiₓCo_{1-y-z}Ni_{y}(M₄)_{z}O_{2-w}X_{w} [Chemical Formula 7]
wherein, in Chemical Formulae 2 to 7,
M₁, M₂, and M₃ are independently selected from the group consisting of Al, Co, Fe, Mg, Mn, Ni, Ti, and a combination thereof,
M₄ is selected from the group consisting of Al, Co, Cr, Ni, Fe, Mg, Mn, Sr, V, a rare earth element, and a combination thereof,
D is an element selected from the group consisting of O, F, S, P, and a combination thereof,
X is an element selected from the group consisting of F, S, P, and a combination thereof,
0.99≦a≦1.1, 2≦b≦4, 0≦p≦0.9, 0≦q≦0.9,
0.9≦x≦1.1, 0≦y≦0.5, 0≦z≦0.5, and 0≦w≦2.

8. The positive active material of claim 1, wherein the lithiated intercalation compound and the compound of Chemical Formula 1 are comprised in a weight ratio of about 80:20 to about 97:3.

9. The positive active material for a rechargeable lithium battery of claim 1, wherein the lithiated intercalation compound and the compound of Chemical Formula 1 are comprised in a weight ratio of about 85:15 to about 96:4.

10. A rechargeable lithium battery comprising:
a positive electrode including a positive active material;
a negative electrode including a negative active material; and
an electrolyte,
wherein the positive active material is the positive active material according to one of claim 1 to claim 9.
